(19) United States
(12) Patent Application Publication
(10) Pub. No.: US 2009/0310760 A1
(43) Pub. Date: Dec. 17, 2009

(54) Audio Message Recorder with Flexible Control

(76) Inventors: Judith Neely Coltman, Reading, MA (US); John Gaewsky, Reading, MA (US)

Correspondence Address: Joseph Stecewycz, P.O.Box 1309, Groton, MA, 01450, US

(21) Appl. No.: 12/486,737

(22) Filed: Jun. 17, 2009

Related U.S. Application Data
(60) Provisional application No. 61/132,250, filed on Jun. 17, 2008.

(51) Int. Cl. H04M 1/64

(52) U.S. Cl. 379/88.07

(57) ABSTRACT

An audio recorder comprises: a microphone for receiving analog audio signals; a removable memory cartridge for digitally storing audio message data entries; and a microcontroller for converting the analog audio signals to digital signals and storing the digital signals in the removable memory cartridge.

### CROSS-REFERENCE TO RELATED APPLICATION

The present Application claims the benefit of Provisional Patent Application No. 61/132,250 entitled “Audio Message Recorder with Flexible Control,” filed 17 Jun. 2008 and incorporated by reference herein in its entirety.

### FIELD OF THE INVENTION

The present invention relates to sound recording devices and, more particularly, to digital voice recorders.

### BACKGROUND OF THE INVENTION

One of the types of digital voice recorders found on the market today is configured to record audio passages of varying duration from several minutes to several hours. The recorded audio passages are stored in built-in memory, external memory modules, or both. Although some of these voice recorders include a mechanism for electronically marking and indexing the location of a message, they do not provide a simple way to later access a desired message. Typically, the accessing of the desired message is accomplished by using two or more scroll keys with visual feedback via a small, often hard-to-see readout, such as an LCD display.

Another type of digital voice recorder found on the market is one in which the device records, archives and plays back multiple discrete messages using only memory built into the device. The accessing of the desired message is generally accomplished with discrete user buttons, one button for each message. The number of messages, the length of each message, and other aspects of the recorder control are generally fixed at time of manufacture of the device.

What is needed is an audio recorder/player to collect, group, and archive an unlimited number of recordings without requiring a large internal memory component.

### BRIEF SUMMARY OF THE INVENTION

In one aspect of the present invention, an audio recorder comprises: a microphone for receiving analog audio signals; a removable memory cartridge for digitally storing audio message data entries; and a microcontroller for converting the analog audio signals to digital signals and storing the digital signals in the removable memory cartridge.

The additional features and advantage of the disclosed invention is set forth in the detailed description which follows, and will be apparent to those skilled in the art from the description or recognized by practicing the invention as described, together with the claims and appended drawings.

### BRIEF DESCRIPTIONS OF THE DRAWINGS

FIG. 1 is a diagrammatical illustration of an audio recording system including an audio recorder, in accordance with an exemplary embodiment of the present invention, the audio recorder including a speaker, a microphone, an indicator, and a keypad;

FIG. 2 is a partial-cutaway of the audio recorder of FIG. 1 showing an electrical circuit board with a microcontroller, a memory cartridge slot, and a battery compartment;

FIG. 3 is diagram illustrating a memory allocation map of a removable serial flash memory cartridge configured for insertion into the memory card slot of FIG. 2;

FIG. 4 is diagrammatical illustration of a flash memory storage package, in accordance with the prior art;

FIG. 5 is diagrammatical illustration of a alternative flash memory storage package, in accordance with the prior art;

FIG. 6 is a flow diagram illustrating the beginning steps in a record or play sequence of the audio recording system of FIG. 1;

FIG. 7 is a flow diagram illustrating the steps taken to initiate a record cycle for the audio recording system of FIG. 1;

FIG. 8 is a flow diagram illustrating the “Play # of lowest message address not yet recorded” for the audio recording system of FIG. 1;

FIG. 9 is a flow diagram illustrating a “Record” mode for the audio recording system of FIG. 1; and

FIG. 10 is a flow diagram illustrating a “Play” mode for the audio recording system of FIG. 1.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The present invention relates to an audio record and playback system for digitally archiving multiple discrete audio messages and, more particularly, to an audio recorder/player which stores a plurality of recorded messages of relatively short duration in a digital memory. The digital memory is provided in a removable and interchangeable memory cartridge. Furthermore, the removable memory cartridge includes pre-loaded information which, when read by the audio recorder/player, contributes to the control of the audio record and playback system. In addition, the audio record and playback system includes a numeric keypad for easy message indexing and voice prompts to eliminate the need for a visual display.

By using removable memory cartridges, instead of internal, built in memory components, the user realizes the advantage of purchasing a single recorder to collect, group, and archive an unlimited number of recordings, merely by purchasing additional removable memory cartridges. Additionally, the removable memory cartridges may be pre-loaded with a few bytes of data referred to as a configuration code. The configuration code, when read by the audio recorder/player, specifies a variety of control functions.

Such functions include: the number of discrete messages, the duration of each message, the sound quality of each message, and the presence and location of audio messages that have been pre-loaded into the removable memory cartridge. By including the configuration code in the removable memory cartridge, a memory cartridge manufacturer can provide the customer with different options, even after the audio recorder has been purchased by the consumer. The configuration code may be pre-loaded at the factory by the manufacturer, by a retailer, or pre-loaded by the customer with his or her own preferences.

A user may benefit from commercially-provided pre-loaded messages, such as: birthday or other special theme related music, voice, or sound effect audio clips. In addition, a memory cartridge may be created with a specific popular media or commercial theme. The presence and location of these pre-loaded messages are communicated to the audio recorder/player via data in the configuration code.

Another use of pre-recorded voice, music and sound messages that are pre-loaded into the removable memory cartridge may be for product promotion utilization within stores and at trade shows. The pre-loaded messages can be used to demonstrate the use of the product. The configuration code communicates to the audio recorder/player the location of these pre-loaded messages and whether these locations are not to be recorded over (i.e., “write protected”).

The disclosed audio recorder/player may also include voice prompts that guide the user in operation. Through the use of voice prompts, the need for a visual display, such as an LCD, can be eliminated. Elimination of the LCD is desirable for many reasons: lowering the system cost, reducing the physical size of the recorder, and removing the obstacles involved in viewing the LCD in a variety of lighting conditions and with a variety of eyesight capabilities.

Pre-loading the voice prompts into the memory cartridge, instead of the recorder itself, yields a flexible way to provide voice prompts in different languages. A single version of recorder can then be sold regardless of language preference with the memory cartridge providing the language preference for the customer.

A keypad provides a simple, familiar, and intuitive method of selecting a memory address for recording and for playing a message. The user may select a desired message by keying in the message number with the numeric keypad. When in the record mode, the audio recording and playback system will automatically identify the next available, unrecorded message address. This identification can be communicated to the user via a voice prompt.

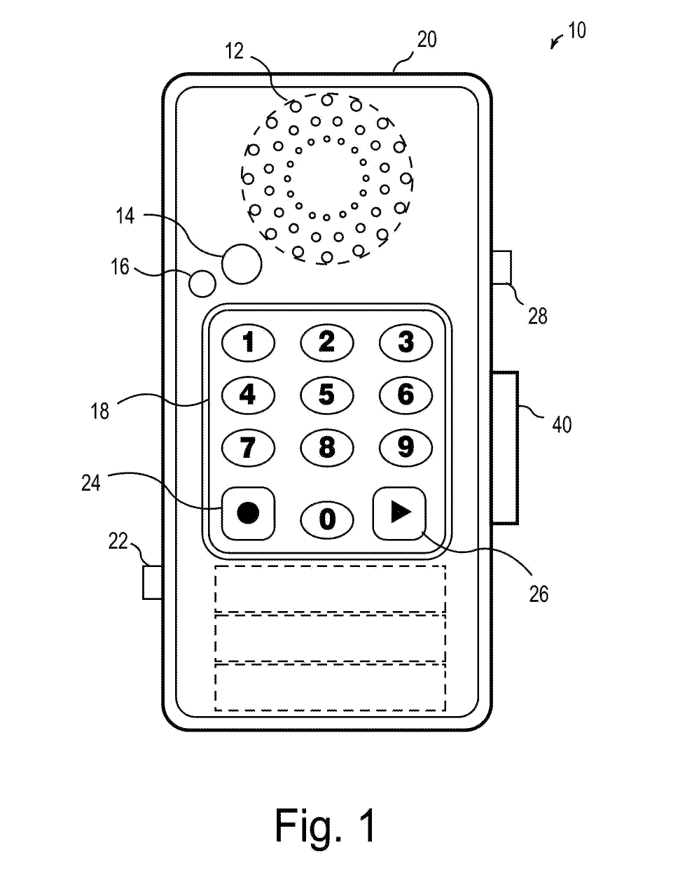

There is shown in FIG. 1 an exemplary embodiment of an audio messaging system 10 comprising an audio recorder 20 and a removable memory cartridge 40. The audio recorder 20 performs both digital recording and digital playback functions, as described in greater detail below. Operational features of the audio recorder 20 include a speaker 12 for outputting analog audio signals, a microphone 14 for receiving analog audio signals, a visual indicator 16, such as an LED, and a keypad 18. The operational features enable a user to access and use the capabilities of the audio recorder 20. Audio controls for the audio recorder 20 include an “on/off” switch 22, a “RECORD” button 24, a “PLAY” button 26, and a volume control switch 28. The audio controls enable the user to selectively record and play back messages digitally using selected solid state memory in the removable memory cartridge 40, as described in greater detail below.

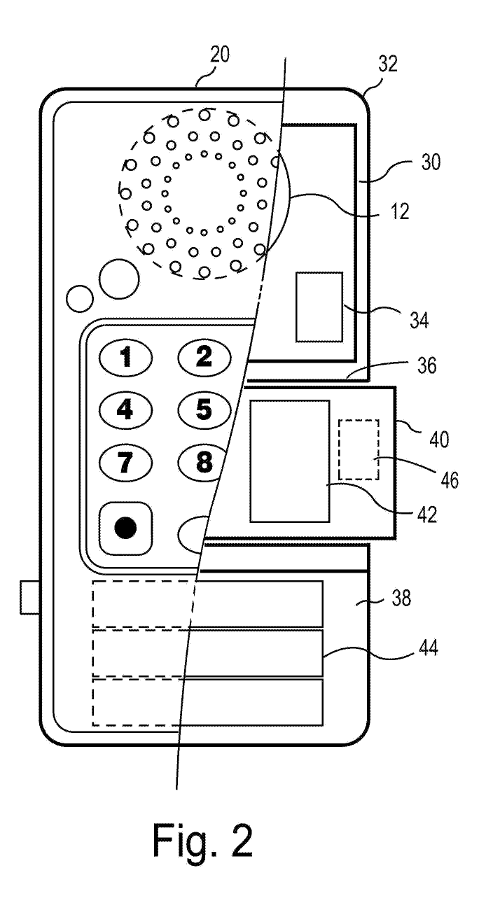

As shown in the partial-cutaway diagrammatical illustration of FIG. 2, the audio recorder 20 includes a housing 32 configured to enclose an electrical circuit board 30. The electrical circuit board 30 includes a microcontroller 34 that executes and controls various functions of the audio recorder 20, such as converting analog audio signals from the microphone 14 to digital signals, and converting digital signals to analog audio signals for the speaker 12, as described in greater detail below. The microcontroller 34, keypad 18, the speaker 12, the microphone 14, the visual indicator 16, the keypad 18, the “on/off” switch 22, the “RECORD” button 24, the “PLAY” button 26, and the volume control switch 28 remain in electrical communication with one another during operation of the audio recorder 20. The audio recorder 20 may further include a memory cartridge slot 36 for providing retention of and electrical communication with the removable memory cartridge 40. The removable memory cartridge 40 comprises a serial flash memory and may include a flash memory integrated circuit 46, such as a 16-megabit CMOS flash memory device commercially available from Spansion Inc., Sunnyvale, Calif.

The flash memory integrated circuit 46 is also in electrical communication with the microcontroller 34 by means of electrical conductive paths (not shown) provided between specified electrical leads on the microcontroller 34 and corresponding electrical contacts in the memory cartridge slot 36. The flash memory integrated circuit 46 generally functions by accepting data from the microcontroller 34, eight bits at a time, written to a serial input. The flash memory integrated circuit 46 also functions by outputting data on a serial output to the microcontroller 34, also at eight bits at a time. The flash memory integrated circuit 46 can be programmed one to 256 bytes at a time. A label 42 may be provided to assist the user in identifying the contents of the removable memory cartridge 40. Electrical power for the audio recorder may be provided by batteries 44, or other replaceable power sources, retained in a battery compartment 38.

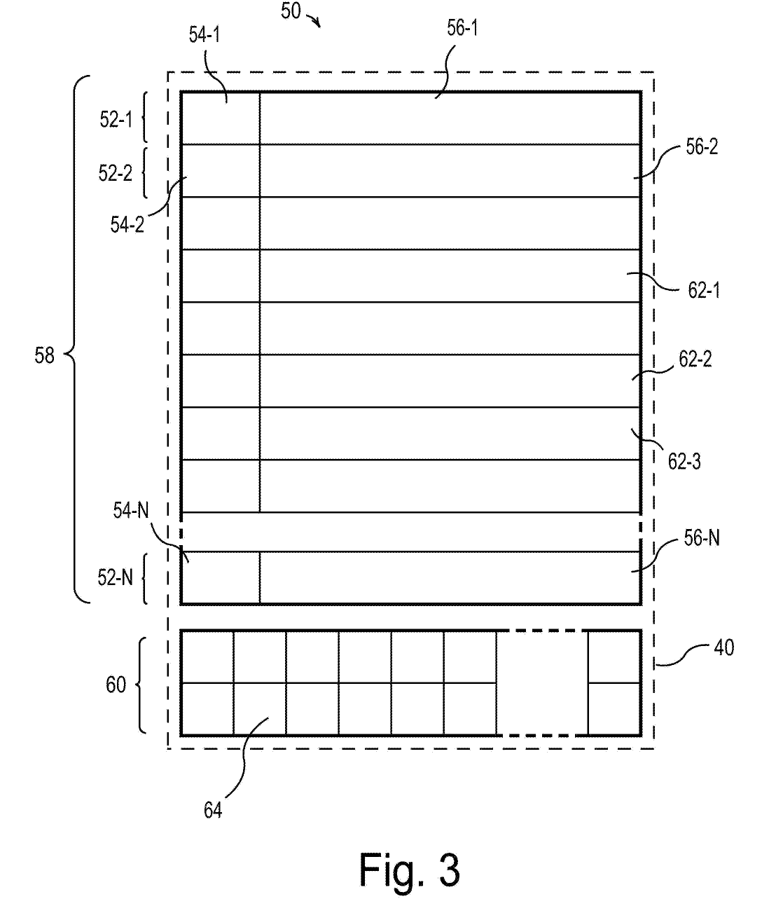

Referring now to FIG. 3, there is shown a diagrammatical memory map 50 as may be formatted onto the removable memory cartridge 40. In an exemplary embodiment, the memory map 50 may include a message memory 58 and configuration data 60. The message memory 58 includes a plurality of audio message data entries 52-1 through 52-N, where each audio message data entry 52-1 through 52-N may include a memory storage address 54-1 through 54-N and a corresponding digitized audio message file 56-1 through 56-N. The ending address for each audio message file 56-1 through 56-N may be determined by the message length.

The configuration data 60 may be used for storing operational information for the audio recorder 20. The message memory 58 may include a pre-loaded audio message 62-1, a pre-loaded theme message 62-2, and/or a preloaded voice prompt with sound 62-3. Alternatively, the voice prompt with sound 62-3 may be stored in the configuration data 60. The configuration data 60 may include a unique configuration code 64. The configuration code 64 may indicate the size of the message memory 58 and/or the number of digits (i.e., one or two) in a message number. The message number refers to the number assigned to the discrete section of memory reserved for a particular recording. In an exemplary embodiment, a 16-megabit flash memory integrated circuit may provide storage capacity for about thirty digitized audio messages, each message approximately thirty seconds long. In an alternative exemplary embodiment, the microcontroller 34 may also provide audio compression of about ten to one (10:1).

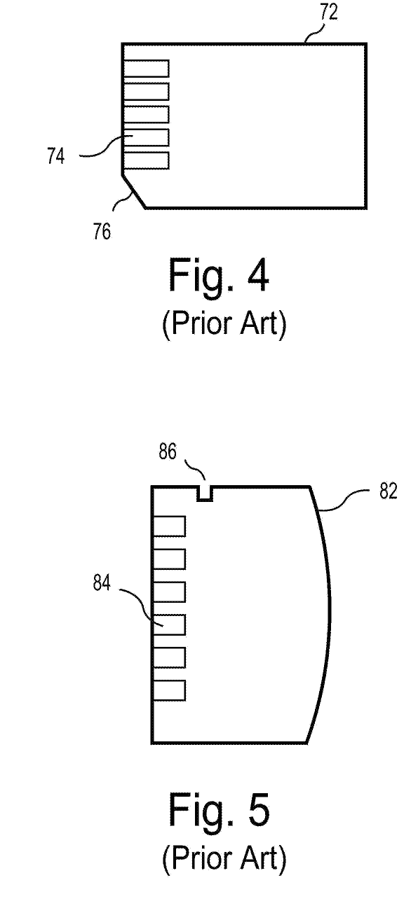

The audio recorder 20 may be configured to accommodate any of a number of commercially available removable flash memory device packages to house the removable memory cartridge 40 including, for example, memory devices packages manufactured by: SanDisk of Milpital, Calif.; Matsushita of Osaka, Japan; Sony of Tokyo, Japan; or Toshiba of Tokyo, Japan. FIG. 4 is a diagrammatical representation of a flash memory package 72 having a generally rectangular shape with a generally narrow width-to-height aspect ratio. The flash memory package 72 includes a plurality of electrical contacts 74 and may include a chamfer 76 to provide for proper insertion into the memory cartridge slot 36 of the audio recorder 20. It should be understood that the memory cartridge slot 36 includes a corresponding set of electrical contacts (not shown) to allow electrical communication between the flash memory integrated circuit 46 in the removable memory cartridge 40 and the microcontroller 34 in the electrical circuit board 30, as described above. It should be understood that most commercially available flash memory devices include two integrated circuits. A first integrated circuit serves as an interface and control unit, and the second integrated circuit serves as a memory unit. However, the removable memory cartridge 40 of the present invention comprises a single integrated circuit, which serves as a memory. It can be appreciated by one skilled in the art that, as data is stored serially in a single integrated circuit in the removable memory cartridge 40, a second interface integrated circuit is not required for operation as disclosed herein.

An alternative commercial flash memory package 82, shown in FIG. 5, may be generally rectangular in shape with a relatively wide aspect ratio. The flash memory package 82 includes a plurality of electrical contacts 84 and may include a notch 86 to provide for proper orientation when being inserted into the memory cartridge slot 36. As can be appreciated by one skilled in the art, the memory cartridge 40 may be available to the user in various memory sizes and having different storage attributes. This storage information may be provided on the label 42 and in the configuration data 58. Accordingly, when the memory cartridge 40 is inserted by the user into the memory cartridge slot 36, the microcontroller 34 on the electrical circuit board 30 reads and interprets one or more of the pre-loaded audio message 62-1, the pre-loaded theme message 62-2, the preloaded voice prompt with sound 62-3, and the unique configuration code 64, as shown in FIG. 3.

When the removable memory cartridge 40 is not being used for recording or playback, the removable memory cartridge 40 may be stored with associated memorabilia related to the audio messages. If so desired, the user can tag these memorabilia with a number that corresponds to the particular audio message that is stored within the removable memory cartridge 40.

The removable memory cartridge 40 may thus be used for system configuration, memory control, and storage of audio recordings made by the user. For each audio message recorded into flash memory by the user, the microcontroller 34 may assign a unique memory storage address, corresponding to one of the memory storage addresses 54 in the memory map 50, shown in FIG. 3, and saved in the corresponding audio message file 56. Each memory storage address 54 may also be assigned a hexadecimal number with which the user can access the message using the keypad 18. The preloading of the audio message 62-1, the theme message 62-2, the voice prompt with sound 62-3, and the unique configuration code 64, can be accomplished in the manufacturing facility, by a service organization, by the retailer, or even by the user.

The configuration code 64 may be used for a variety of system configuration attributes and memory control such as, but not limited to: the number of audio message files 52-N; the length of the audio message files 56-N; the location of the pre-loaded audio message 62-1; the location of the pre-loaded theme messages 62-2, and the quality of the messages to be recorded. In addition to the configuration code 64, the flash memory also can include additional data, such as a pre-loaded demonstration message and demo theme messages to be used as demonstrations to potential customers. The pre-loaded voice prompts and sounds 62-3 may be accessed to guide the user in the operation of the audio messaging system 10.

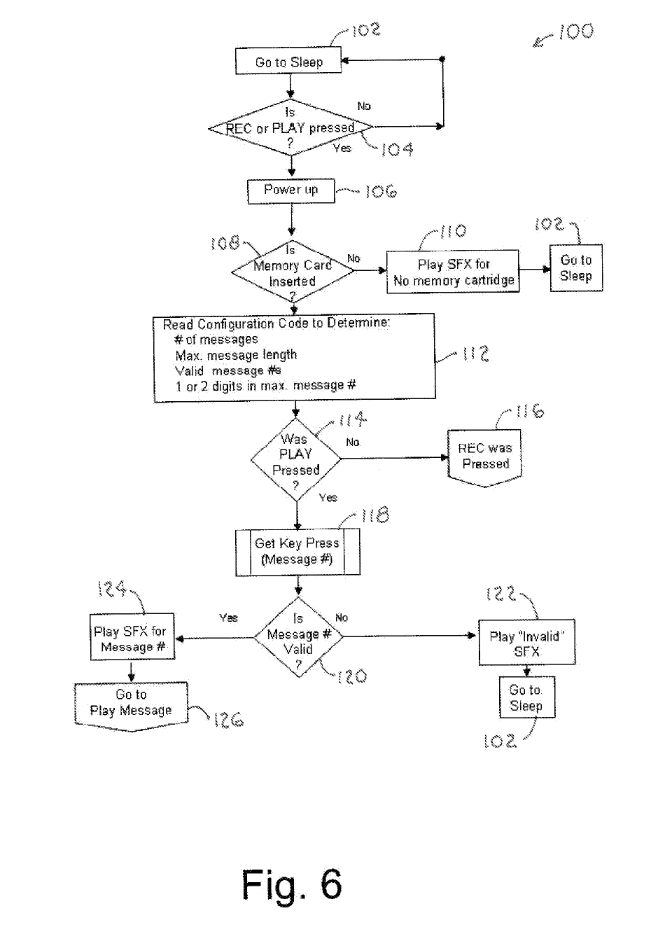

To begin operation of the audio messaging system 10, a user may select a specific removable memory cartridge 40 based upon its attributes, as defined on the label 42, and insert the removable memory cartridge 40 into the audio recorder 20. Operation of the audio messaging system 10 can be described with reference to a flow diagram 100, shown in FIG. 6. If the on/off switch 22 is in the “ON” position, and the audio recorder 20 is not being used for either recording or playing, the audio recorder 20 remains in a “sleep mode,” at step 102. That is, the electrical circuit board 30 assumes a low power mode when not in use. Once either the record button 24 or the play button 26 is pressed or activated, at decision block 104, the audio recorder 20 powers up, at step 106, and a determination is made, at decision block 108, as to whether the removable memory cartridge 40 has been inserted into the memory cartridge slot 36.

If no removable memory cartridge 40 is detected, at decision block 108, a predetermined sound effect (SFX) may be generated by the microcontroller 34 to indicate that the user is attempting to use the audio recorder 20 without a removable memory cartridge 40 in place, at step 110, and the audio recorder 20 returns to the sleep mode, at step 102. If a removable memory cartridge 40 is detected, at decision block 114, the configuration code 64 (see FIG. 3) is read to determine one or more of the following configuration data: the number of messages stored on the removable memory cartridge 40, the maximum message length in the message memory 58, the number of “valid” messages stored, and the number of digits in the “maximum message number,” at step 112.

A message number refers to the number assigned to the discrete section of the message memory 58 for a particular recording, or recorded message. Each message number will have a corresponding starting address in the message memory 58. The ending address for each message will be determined by the length of the message. A valid message number is a number lying between one and the maximum number of messages in the message memory 58. The maximum message number is equal to the highest message number. For example, if thirty (30) messages are to be recorded into the message memory 58, the highest message number will be thirty (30). Valid message numbers, therefore, will be one (1) through thirty (30), and invalid message numbers will be zero (0) and any number greater than thirty (30).

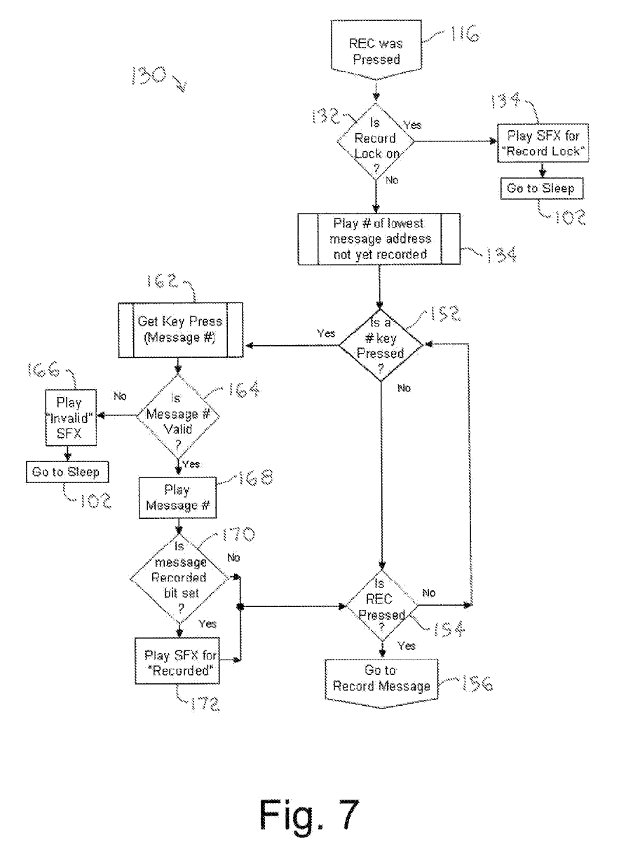

If a determination is made, at decision block 114, that the RECORD button 24 had been pressed, at step 116, a “pre-RECORD” sequence 130 is followed, as shown in FIG. 7. If, on the other hand, the determination is made, at decision block 114, that the PLAY button 26 had been pressed, the number and identity of the key(s) pressed by the user is obtained, at step 118. That is, one key may have been pressed (i.e., one key press) to indicate stored message one (1) through nine (9), or two keys may have been pressed (i.e., two key presses) to indicate a message number of ten (10) or higher. The maximum number of valid key presses allowable may be determined by reading the configuration code 64, and by determining the maximum number of messages in the message memory 58.

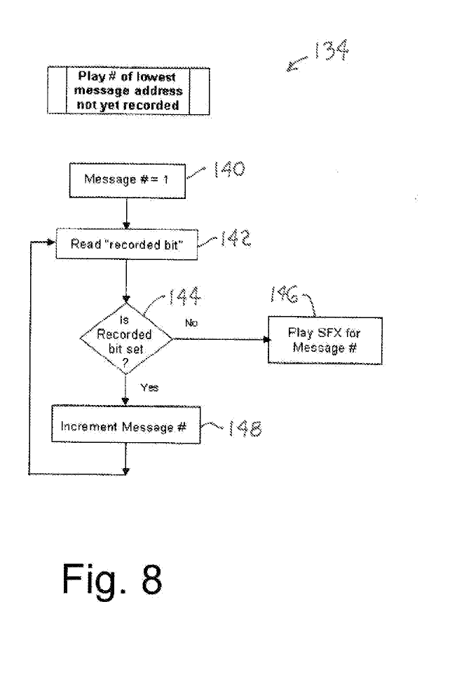

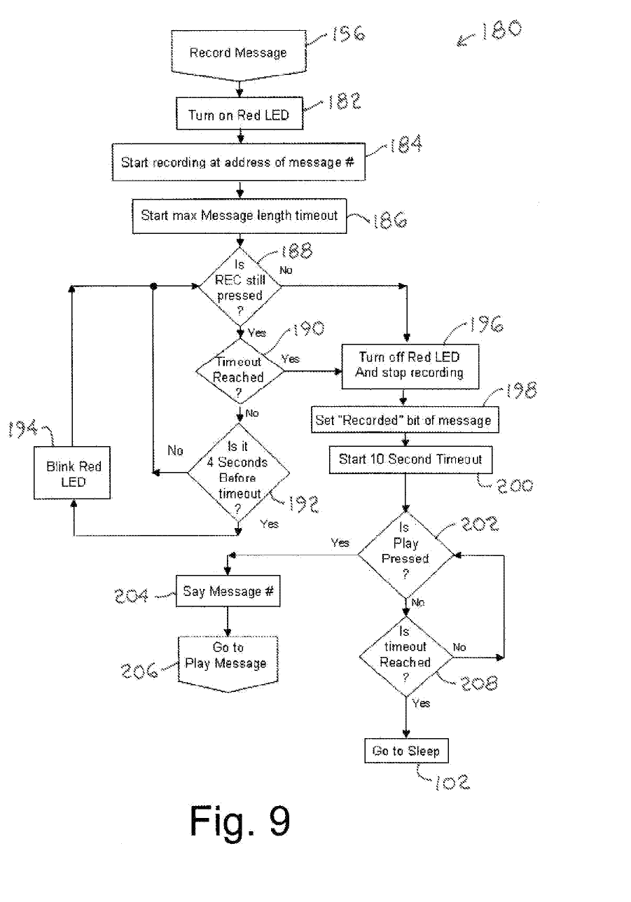

If the message number is not a valid number, at decision block 120, a predetermined “invalid message number” tone, or “invalid SFX,” may be generated, at step 122, and the audio recorder 20 returns to the sleep mode, at step 102. If, on the other hand, the message number is a valid number, at decision block 120, a predetermined “valid message number” tone, or “valid SFX,” may be generated, at step 124, and a “PLAY” sequence 150, shown in FIG. 8, is initiated, at step 126.

The audio recorder 20 may read the configuration code 64 to determine control functions. The audio recorder may “say” the number of the next available message location, e.g. “SIX”. If an alternate message number is desired, the user may press a numeric key on the keypad 18 to select an alternate message number. The audio recorder may “say” the alternate message number.

In the “pre-RECORD” sequence 130, shown in FIG. 7, the user has pushed or activated the RECORD button 24, at step 116. This operation may be prevented by activation of a record lock (not shown) in the audio recorder 20. If the record lock is on, at decision block 132, a “record locked SFX” may be played, at step 134, and the audio recorder 20 returns to the sleep mode, at step 102. If, at decision block 132, it is determined that the record lock is not on, the lowest message number for an unrecorded or “empty” audio message data entry 52 is found and played, at step 134. The step 134 for determining the PLAY number of an unrecorded message is described in greater detail in FIG. 8. After setting the message number to one (1), a “recorded” bit is read, at step 142.

If the bit is found to be “set,” at decision block 144, the message number is incremented, at step 148, and the “recorded” bit is read again. The steps 142 and 148 are repeated until a “record” bit is found that has not been set. At this point, at step 146, a predetermined SFX is played giving the message number of an unrecorded message location, and the process goes to a decision block 152, in FIG. 7, where a determination is made as to whether a numeric key has been pressed.

If no numeric key on the keypad 18 has been pressed, at decision block 152, a determination is made as to whether the RECORD button 24 has been pressed. If the RECORD button 24 has been pushed or activated by the user to record a message, at decision block 154, the process continues to a RECORD routine 180, at step 156. If the RECORD button 24 has not been pressed or activated, at decision block 154, the process returns to decision block 152.

If a numeric key on the keypad 18 has been pressed, at decision block 152, the key presses are obtained, at step 162, to derive the message number of an unrecorded message location. If the message number so obtained is determined to be an invalid number, at decision block 164, an “invalid message number SFX” may be played, at step 166, and the process returns to step 102. If a valid message number has been obtained, as determined at decision block 164, the audio recorder 20 may play the valid message number via the speaker 12, at step 168. If a “message recorded” bit has been set, at decision block 170, a determination is made as to whether the RECORD button 24 has been pressed or activated, at decision block 154. Otherwise, a “recorded SFX” may be played, at step 172, and the process continues to decision block 154.

If the RECORD button 24 had been pressed or activated, at decision block 154, the process continues to the record process 180, at step 156. A record LED, which may serve as the visual indicator 16, may turn on during recording, at step 182. Recording is executed, at step 184, and the audio message file is stored at the message number obtained in step 168, above. The maximum message length or duration is obtained, at step 186, to provide a timeout value. If the RECORD button 24 is still in a pressed state, at decision block 188, a determination is made, at decision block 190, as to whether the timeout value has been reached.

If the timeout has not been reached, but the timeout is to occur within a predetermined time interval, here denoted as four (4) seconds, the visual indicator 16 may provide a signal to the user, such as a blinking red LED, for example. If more time remains than provided for by the time interval, at decision block 192, the process returns to the decision block 188. The recording process may end when the RECORD button 24 is released, or when maximum recording duration is reached. In this state, the visual indicator 16 may turn off, at step 196. The “recorded” bit is set for the corresponding audio message file 56, at step 198.

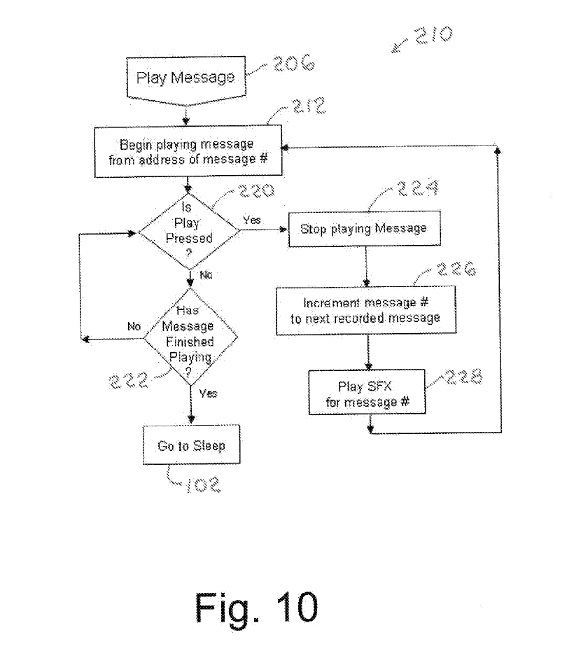

In an exemplary embodiment, a ten-second timeout may be initiated, at step 200. Otherwise, the audio recorder 20 may return to a sleep state, at step 102. The user may push the PLAY Button 26 to review the most recently recorded message, at decision block 202. Then, at step 204, the audio recorder may “says” the number of the message just recorded, e.g., “SIX”, and then may play the newly-recorded message, at step 206, by going to a PLAY routine 210, shown in FIG. 10. If the user has not pressed the PLAY button 26, at decision block 202, a determination is made, at decision block 208, as to whether the timeout has been reached. If so, the audio recorder 20 may return to the sleep state, at step 102. Otherwise, the process may return to the decision block 202.

In the PLAY routine 210, the user may push the PLAY button 26 and may then use the keypad 18 to select the message number obtained above, at step 212. The audio recorder 20 may reads the configuration code 64 to determine control functions. The audio recorder may “say” the message number selected, e.g. “SIX”, and if the PLAY key 26 is pressed, at decision block 220, the audio recorder plays the message that corresponds to the keypad press, e.g. message #6.

If the message has finished playing, at decision block 222, the audio recorder 20 may enter the sleep state, at step 102. Otherwise, the process returns to decision block 220 to determine whether the PLAY key 26 is still being pressed. If not, the audio recorder 20 may stop playing the message, at step 224, and increment a counter to play the next recorded message, at step 226. An SFX may be played stating the message number, at step 228, and the process returns to step 212.

The user can label an object that relates to a recorded message with the number of the message. For instance, the user may record the description of a photograph into message number 6. On the back of the photograph the user may adhere a sticker which has the number “6” printed on it. Furthermore, the user can label the removable memory cartridge 40 with words that describe the set of audio recordings contained in the respective memory cartridge 40. For example, if the recorded messages all describe photographs of daughter “Jennifer” from birth to year one, the memory cartridge can be labeled, “Jennifer's first year”.

It is to be understood that the description herein is exemplary of the invention only and is intended to provide an overview for the understanding of the nature and character of the invention as it is defined by the claims. The accompanying drawings are included to provide a further understanding of various features and embodiments of the method and apparatus of the invention which, together with their description serve to explain the principles and operation of the invention. Thus, while the invention has been described with reference to particular embodiments, it will be understood that the present invention is by no means limited to the particular constructions and methods herein disclosed and/or shown in the drawings, but also comprises any modifications or equivalents within the scope of the claims.

What is claimed is:

1. An audio recorder comprising:
a microphone for receiving analog audio signals;
a removable memory cartridge for digitally storing audio message data entries; and
a microcontroller for converting said analog audio signals to digital signals and storing said digital signals in said removable memory cartridge.

2. The audio recorder of claim 1 wherein said removable memory cartridge comprises a serial flash memory.
